(19) United States
(12) Patent Application Publication
(10) Pub. No.: US 2012/0166226 A1
(43) Pub. Date: Jun. 28, 2012

(54) HEALTHCARE MANAGEMENT SYSTEM

(76) Inventors: Christine Lee, Rocklin, CA (US); Grover Lee, Rocklin, CA (US)

(21) Appl. No.: 13/335,826

(22) Filed: Dec. 22, 2011

Related U.S. Application Data
(63) Continuation-in-part of application No. 12/607,935, filed on Oct. 28, 2009.

(51) Int. Cl. G06Q 50/22

(52) U.S. Cl. 705/3

(57) ABSTRACT

Managing medical care. An electronic medical record is displayed having data related to a patient on an electronic device using a graphical interface that emulates a standard paper medical chart. Additional information from a healthcare provider regarding the patient is received at the electronic device wherein the additional information is received in data fields associated with the graphical interface. The additional information is sent to a database which comprises data related to medical records of the patient integrated from multiple sources. An alert regarding a gap in a treatment of the patient and the alert displayed on the electronic medical record at the electronic device wherein the gap in treatment is discovered using data from the data related to medical records.

### RELATED APPLICATIONS

The present application is a Continuation in Part of pending U.S. patent application Ser. No. 12/607,935, Attorney Docket No. 31002/00003, entitled “HEALTHCARE MANAGEMENT SYSTEM” with the filing date of Oct. 28, 2009, and which is herein incorporated by reference in its entirety.

### TECHNICAL FIELD

Embodiments of the present technology relate to healthcare management systems and methods. More specifically, embodiments of the present technology relate to web-based electronic systems for supporting online medical records and treatment plans/options.

### BACKGROUND ART

Health plans, hospitals, physicians and other medical service institutions retain records of patient information, including doctors' notes, treatment history, and so forth. To this end, health plans, hospitals, and physicians use databases dedicated to maintaining and managing electronic medical documents and other patient information. Such databases retain data relating to all patients, including current patients and non-current patients, and include all medical information collected for each current and non-current patient. Thus, such databases can be quite large.

Patient information system databases are designed to handle large quantities of data and have limited, rigid, protocols for storing and retrieving information that can be difficult and/or time-consuming to learn. Unfortunately, conventional patient information systems are not adapted for convenient, everyday use by doctors or other caregivers.

### BRIEF DESCRIPTION OF THE FIGURES

A more complete understanding of the present technology and the attendant features and advantages thereof may be had by reference to the following detailed description when considered in conjunction with the accompanying drawings wherein:

FIG. 1 shows an overview flow diagram of the healthcare management system (“HMS”) system.

FIG. 2 is a flow diagram depicting information gathering during a patient visit and integrating it with the patient medical records, disease states, medication, treatment protocols, national guidelines based on the above data as well as age and gender and then forms options to formulate a treatment plan and follow-up for the patient.

FIG. 3 illustrates a case overview using the HMS systems and methods.

FIG. 4 illustrates the logical architecture for the HMS systems and methods.

FIG. 5 illustrates the logical architecture for the HMS systems and methods to ensure security of the information inputted and outputted from the databases and networks.

FIG. 6 illustrates the process architecture for the HMS systems and methods.

FIG. 7 shows a schematic diagram of an exemplary system of various databases and software modules.

FIG. 8 illustrates an integrated HMS using the tools claimed by this technology.

FIG. 9 show exemplary pharmacy data formats for use in the HMS systems and methods.

FIG. 10 shows exemplary medical data formats for use in the HMS systems and methods.

FIG. 11 is an example illustrating the basic user-to-user model.

FIG. 12 is an example of a flowchart for managing medical care in accordance with embodiments of the present technology.

FIG. 13 is a block diagram of an interface in accordance with embodiments of the present technology.

### DESCRIPTION OF EMBODIMENTS

The following detailed description of embodiments of the present technology references the accompanying drawings that illustrate specific embodiments in which the technology can be practiced. The embodiments are intended to describe aspects of the technology in sufficient detail to enable those skilled in the art to practice the technology. Other embodiments can be utilized and changes can be made without departing from the scope of the present technology. The following detailed description is, therefore, not to be taken in a limiting sense. The scope of the present technology is defined only by the appended claims, along with the full scope of equivalents to which such claims are entitled.

For example, the steps recited in any of the method or process descriptions may be executed in any order and are not limited to the order presented. Moreover, any of the functions or steps may be outsourced to or performed by one or more third parties. Furthermore, any reference to singular includes plural embodiments, and any reference to more than one component may include a singular embodiment.

Conventional data networking, application development and other functional aspects of the systems (and components of the individual operating components of the systems) may not be described in detail herein. Furthermore, the connecting lines shown in the various figures contained herein are intended to represent exemplary functional relationships and/or physical couplings between the various elements. It should be noted that many alternative or additional functional relationships or physical connections may be present in a practical system.

Referring to the figures, the block system diagram and process flow diagram represent mere embodiments of the technology and are not intended to limit the scope of the technology as described herein. For example, the steps recited in each of the figures may be executed in any order and are not limited to the order presented.

The term “user” refers to any person, having a secure authorization code, accessing and/or utilizing the healthcare management system (“HMS”).

The term “user device” is meant to refer to any electronic device or method of electronic communication over the Internet or wireless network, such as notebook computers, cellular telephones, personal data assistants (PDAs), smart-phones, tablets, touch screen devices, handheld devices, mobile devices, and other similar communication devices having Internet access.

The term “patient” is a person whose electronic medical document information is used regularly and/or frequently by a caregiver and may include, for example, patients admitted to a hospital and/or patients currently undergoing treatment. This includes a patient whose electronic medical document information is not used regularly or frequently by a caregiver and may include, for example, patients released from a hospital and/or patients no longer receiving treatment.

The term “tools” refers to algorithms and computer software implemented into the HMS to actively target and identify patient risk factors such as disease potential, active disease, current therapies, new therapies, etc. to optimize a patient's course of treatment for improved wellbeing.

The term “healthcare provider” is any personnel associated with providing healthcare for a patient. Such personnel may be, but is not limited to, doctors, physicians, technicians, lab technicians, pharmacists, nurses, nutritionist, assistants, psychologists, therapists, or any other healthcare professional associated with providing healthcare to the patient. For purposes of this application, “healthcare provider” may also refer to personnel who have clearance to view portions of records and data associated with a patient such as computer technicians, billing specialists, or administrators.

The term “medical records” may be synonymous with the terms patient record, patient chart, doctor's chart, medical chart, and the like as well as data associated with these terms. Paper medical records may refer to records and charts on paper or other medium such as cardstock or plastic.

The term “electronic medical document” is a medical record, medical data, or other document unit containing patient-specific healthcare information.

The term “network” includes any electronic communications means which incorporates both hardware and software components of such. Communication among the parties may be accomplished through any suitable communication channels, such as, for example, a telephone network, an extranet, an intranet, Internet, point of interaction device (point of sale device, personal digital assistant (e.g., Palm Pilot®, Blackberry®), cellular phone, kiosk, etc.), online communications, satellite communications, off-line communications, wireless communications, transponder communications, local area network (LAN), wide area network (WAN), networked or linked devices, keyboard, mouse and/or any suitable communication or data input modality. Moreover, although the system is frequently described herein as being implemented with TCP/IP communications protocols, the system may also be implemented using IPX, Appletalk, IP-6, NetBIOS, OSI or any number of existing or future protocols. If the network is in the nature of a public network, such as the Internet, it may be advantageous to presume the network to be insecure and open to eavesdroppers. Specific information related to the protocols, standards, and application software utilized in connection with the Internet is generally known to those skilled in the art and, as such, need not be detailed herein. See, for example, Dilip Naik, Internet Standards and Protocols (1998); Java 2 Complete, various authors, (Sybex 1999); Deborah Ray and Eric Ray, Mastering HTML 4.0 (1997); and Loshin, TCP/IP Clearly Explained (1997) and David Gourley and Brian Totty, HTTP, The Definitive Guide (2002).

The various HMS components may be independently, separately or collectively suitably coupled to the network via data links which includes, for example, a connection to an Internet Service Provider (ISP) over the local loop as is typically used in connection with standard modem communication, cable modem, Dish networks, ISDN, Digital Subscriber Line (DSL), or various wireless communication methods, see, e.g., Gilbert Held, Understanding Data Communications (1996). It is noted that the network may be implemented as other types of networks, such as an interactive television (ITV) network.

The present technology can be implemented in hardware, software, firmware, or a combination thereof. In a preferred embodiment, however, the technology is implemented with a computer program. The computer program and equipment described herein are merely examples of a program and equipment that may be used to implement the technology and may be replaced with other software and computer equipment without departing from the scope of the present technology.

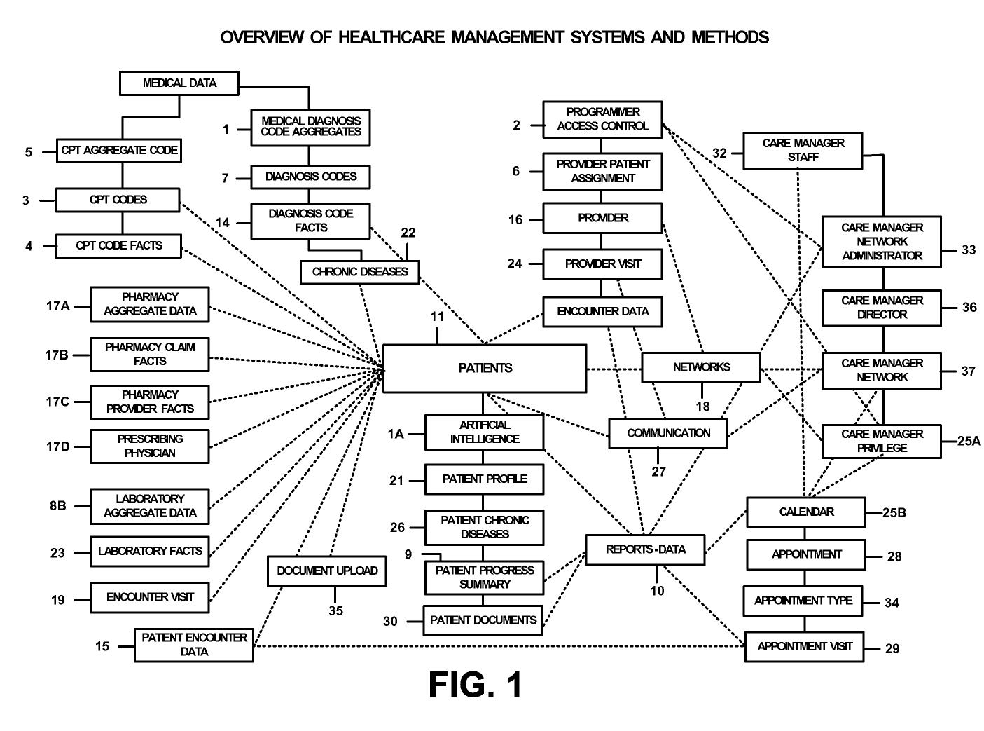

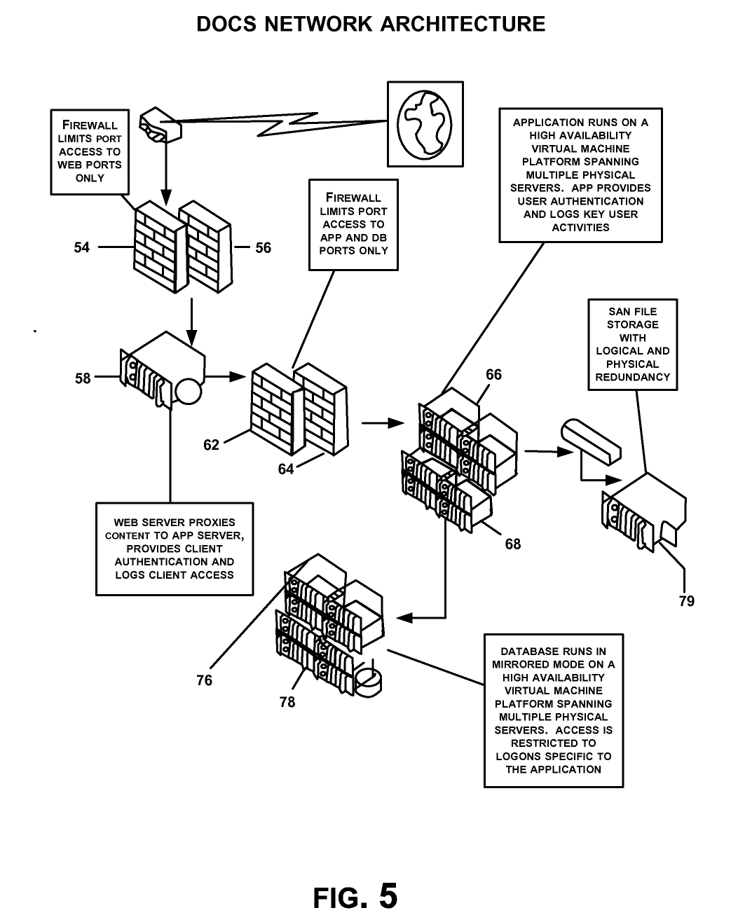

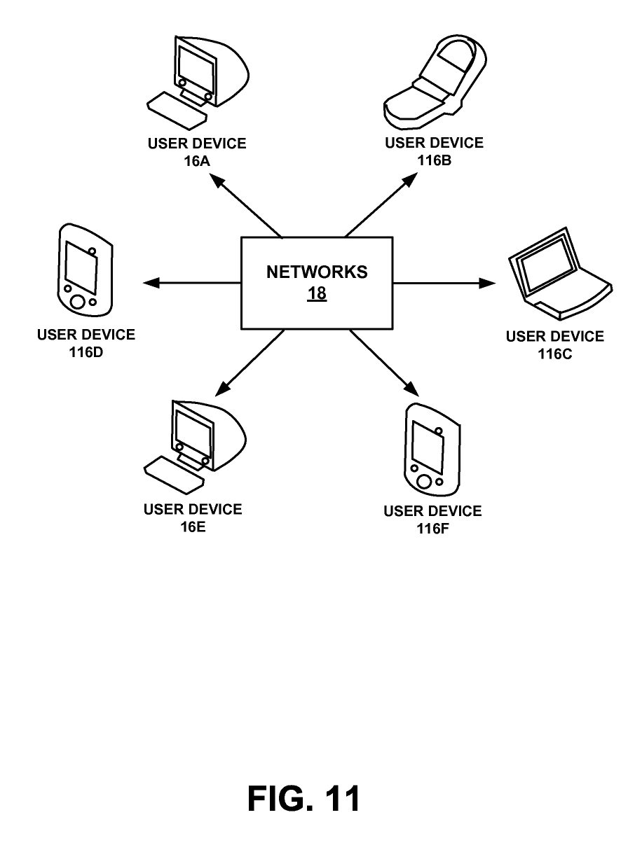

The computer program of the present technology is stored in or on a computer-usable medium, such as a computer-readable medium, residing on or accessible by a host computer for instructing the host computer to implement the method of the present technology as described herein. The host computer may be one or more server computers 58, 60 (FIG. 5) or a network client computer 18 (FIGS. 1 and 11) or the hand-held computing device. The computer program preferably comprises an ordered listing of executable instructions for implementing logical functions in the host computer and other computing devices coupled with the host computer. The computer program can be embodied in any computer-usable medium for use by or in connection with an instruction execution system, apparatus, or device, such as a computer-based system, processor-containing system, or other system that can fetch the instructions from the instruction execution system, apparatus, or device, and execute the instructions.

The executable instructions comprising the computer program of the present technology will hereinafter be referred to simply as “the program”, “the computer program” or “the HMS”. It will be understood by those skilled in the art that the program may comprise a single list of executable instructions or two or more separate lists, and may be stored on a single computer-usable medium or multiple distinct media. The program will also be described as comprising various “code segments,” which may include one or more lists, or portions of lists, of executable instructions. Code segments may include overlapping lists of executable instructions, that is, a first code segment may include instruction lists A and B, and a second code segment may include instruction lists B and C.

As used herein, a “computer-usable medium” may be a non-transitory computer readable storage medium or any means that can contain, store, communicate, propagate or transport the program for use by or in connection with the instruction execution system, apparatus, or device. The computer-usable medium can be, for example, but is not limited to, an electronic, magnetic, optical, electro-magnetic, infrared, or semi-conductor system, apparatus, device, or propagation 8 medium. More specific, although not inclusive, examples of computer-usable media would include the following: an electrical connection having one or more wires, a portable computer diskette or drive including external hard drives and flash drives, a random access memory (RAM), a read-only memory (ROM), an erasable, programmable, read-only memory (EPROM or Flash memory), an optical fiber, and a portable compact disk read-only memory (CDROM). The computer-usable medium could even be paper or another suitable medium upon which the program is printed, as the program can be electronically captured, via for instance, optical scanning of the paper or other medium, then compiled, interpreted, or otherwise processed in a suitable manner, if necessary, and then stored in a computer memory.

The present technology relates to a system and method of electronic medical documentation and patient support tools. FIG. 1 illustrates the various access points for data input and output 1-37. Management of the electronic medical document database may be governed by laws such as the Health Insurance Portability and Accountability Act of 1996 (“HIPAA”). The electronic medical document database 30 may be accessible via a protocol such as Health Level Seven or other messaging standard that enables disparate healthcare applications to exchange patients' personal healthcare information, including clinical and administrative data.

FIG. 1 shows the powerful ability to assimilate all the various types of data that is associated with a patient's medical history and current medical assessment which is obtained from various sources. The patient is shown at the center of the diagram because all information gathered is drilled down to be patient-specific. The medical data 1, 7, 14, and 22 comprise diagnosis codes representing disease states with or without complications, the diagnosis code facts for description, and chronic disease states. The pharmacy component 17A, 17B, 17C, and 17D contains information about what medications are dispensed, what pharmacy dispensed the medication, which physician prescribed the medication, how many pills were dispensed and the days supply. This provides useful information that can be used in determining medication compliance, conflicting medications, medication abuse, and lack of medication, poly-pharmacy or wrong medications.

The laboratory data 8 and 23 give the test names and results. Laboratory data provides bench mark results for baseline health analysis, treatment success or failure and confirms diagnosis.

Encounter data 19 and 15 provide current assessment of the patient visits with care managers, such as blood pressure, feet examine, over-the-counter medications, and clinical information of overall mental and physical health related issues. Such data may also comprise current procedure terminology (CPT) information such as CPT-4 information which may assist in verifying the accuracy of international statistical classification of diseases and related health problems (ICD) information such as ICD-9 codes. Care managers may include physician, pharmacist, nurse practitioners, and nurses, as well as agents of these professionals. Care managers 32, 33, 36, 37, and 25 are divided into networks in which a director is responsible for care managers to provide care to the patient.

The care manager has access to the patient's records through a documentation portal that provides patient-specific information, as discussed in FIG. 1 and action plan through reports and data 10 that have been provided by the artificial intelligence IA. Communication 27 is real time communication in which one or several care managers can communicate health findings or concerns between each other anywhere in the world where access to the internet is available. The access control 2 is only given by the programmer as well as the level of access whether administrative or clinical. The calendar 25B provides scheduling, number of appointments per care manager, and missed appointment through the web.

The data stored in the HMS databases, such as the medical records database, 30, may be compartmentalized and downloaded for efficient access through remote user modules such as handheld computers or PDA's where computer networks are not available. This is helpful in situations where the caregiver, 16, 31, is visiting a remote location beyond range of a wireless communications network, 18. In such situations, the caregiver, 16, 31, is able to view patient data, 15, 19, 22, 26, 30 stored on the handheld computing device. When communications are restored between the client modules and the intermediate database 30, the information obtained can now be input into the computer system.

The program is further operable to automatically import external information 9 (e.g., CPT codes and information, 3, 4, 5; insurance information, 8; pharmacy information, 17 A, B, C, D, 23, 40, 41) into an information template. Certain medical information relating to each patient may be gathered each day, such as weight, blood pressure, temperature, and so forth. The program may store this information in the appropriate databases or otherwise access the information to import it into a particular template upon request by the user such that the template is presented to the user with the external information. Thus, information submitted by the user may be automatically supplemented by contemporaneous external information, saving the user the time required to manually submit the information.

The networks 18 enables communications between the electronic medical document database 21, 26, 9, 30 and the various users such as, providers 16, care managers 31, and other persons or entities authorized with access to the HMS. The electronic medical document database 30 is a database operable to store a plurality of electronic medical documents containing particular patient's medical information, medical documents and notes, historical and current clinical encounter data 49, quality and risk measures 45, pharmacy data 17, and over the counter medications. The database 30 may be comprehensive in that it may store all patient information from both current patients and non-current patients which includes all sources of medical data that is paid through the medical plan as well as encounter data that is input in the database.

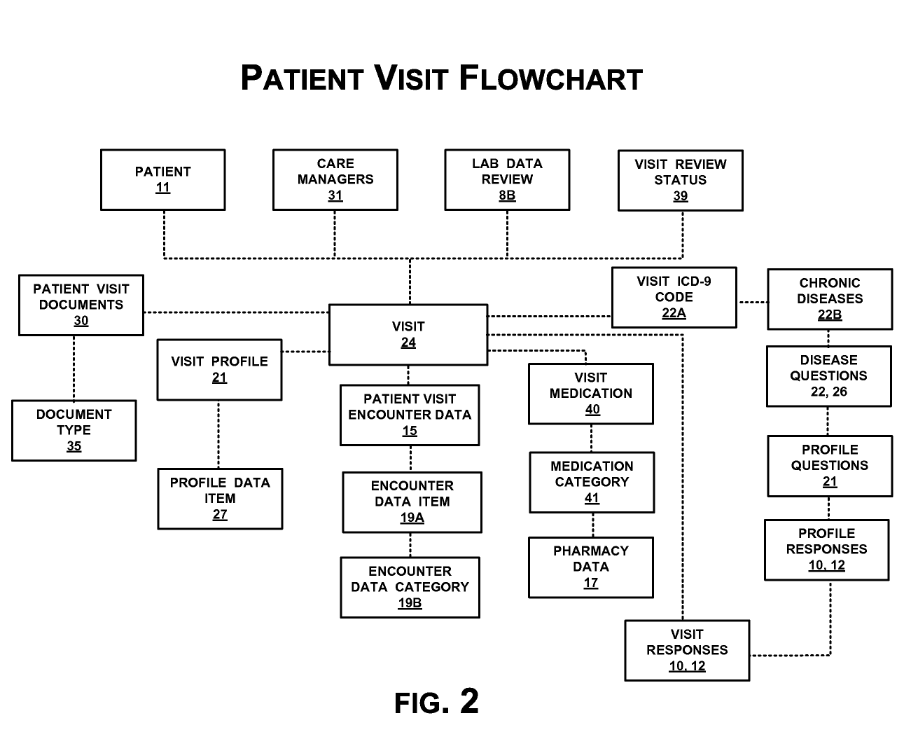

FIG. 2 illustrates the systems and methods for care managers 31 to schedule a patient visit 15, 19, 21, 24, 27, review patient records 30, 35, monitor a patient's health status 21, 22, 39, and authorize treatment options 10, 12, including medications 40, 41. The patient visit flowchart depicts aspects of how a care manager reviews the patient at a visit. There are 3 major areas of review; clinical encounter data and answers to questions 21, 22, 26, 15, 19, 10, 12, medical and pharmacy data that is comprised of 22, 41, 40, 41, and profile data 27 in which the artificial intelligence has analyzed deficiencies, risk and treatment failure and provides actionable items.

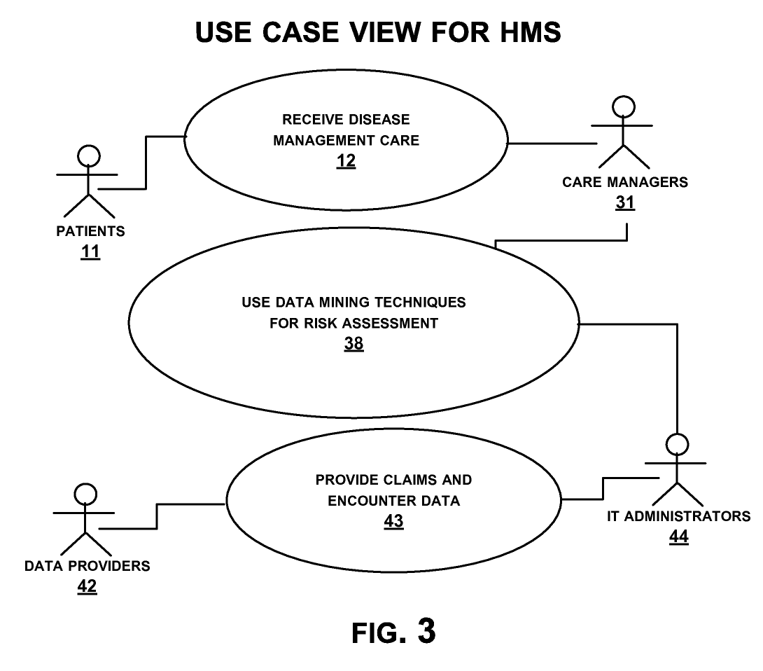

FIG. 3 illustrates a case overview for a particular patient 11 by a care manager 31. The patient 11 receives disease management care 12 from the care managers 31 utilizing the HMS systems which provides data mining techniques for risk assessment 38. The data mining techniques for risk assessment 38 includes each of the components 1-37 identified in FIG. 1. Data providers 42 enter information into the HMS databases to provide claims and encounter data information 43. The claims and encounter information includes the components 3, 4, 5, 9, 15, 19, 22, 27, identified in FIG. 1. The IT Administrators 44 manage the networks to provide maintenance, upgrades, optimization and security monitoring.

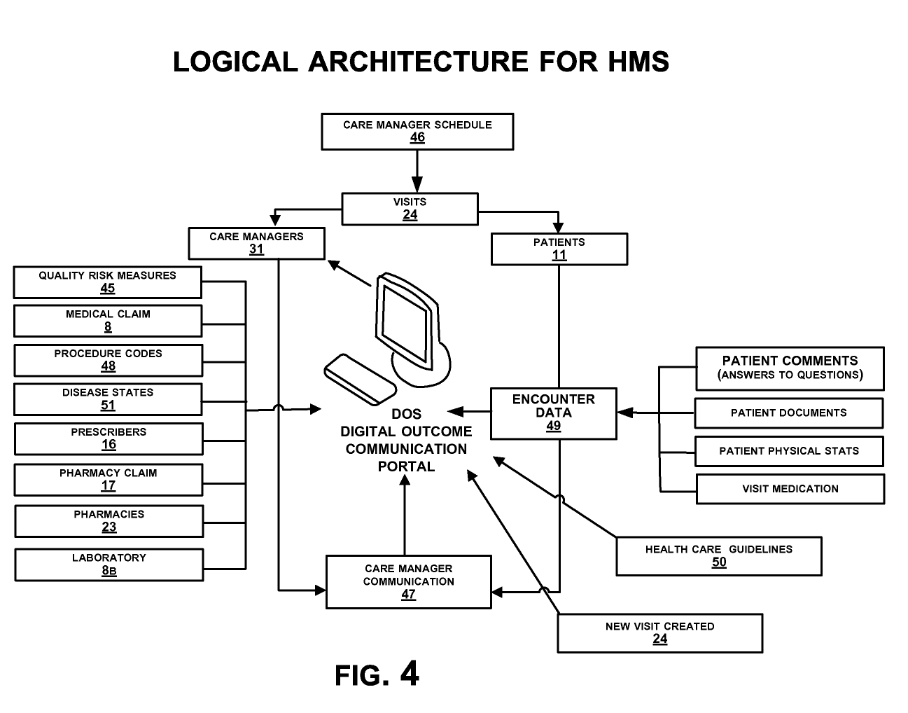

FIG. 4 illustrates the general flow of information and integration of the various HMS components to generate quality risk measures, 45, healthcare guidelines for disease states, gender and age, 50, identify procedures that have been done and what procedures need to be done, 48, medications prescribed, compliance and medication gaps in therapy, 8B, and encounter data, 49, to optimize the patients', 11, healthcare treatments. In this information integration schematic, the care managers, 31, can communicate through the HMS 47 with the 10 necessary healthcare professionals such as physicians, nurse practitioners and pharmacists 17 to prescribe medications, through specific pharmacies, 23.

In one embodiment, data can be gathered from a variety of sources for a patient including, but not limited to documents, medical or doctor charts, prescriptions, pharmaceutical records, medication records, information from the patient, x-rays, lab results, patient symptoms, records of medications, records of treatments, records of procedures, patient tests, healthcare provider notes, comments, prescriptions not filled, missed appointments, procedures performed, lab values, patient history, non-prescription medications taken by patient, herbal medicines used by patient, diet information, and patient vital statistics. Such information may be inputted directly by a doctor or other person or may be uploaded in a document that is made text searchable. The data may be collected from more than one doctor, hospital, clinic, database etc. The data may also include notes or comments from healthcare providers.

In one embodiment, deficiencies, treatment failure, actionable items, risk measures, medication gaps, medication conflicts, etc. may be described as gaps in treatment. The present technology is able to discover or recognize gaps in treatment and send a report or an alert regarding the gap in treatment. In one embodiment, the present technology discovers gaps in treatment by integrating data regarding a patient from a variety of data sources as described. Thus all or nearly all data regarding the medical care of a patient may be accessed by the present technology to discover the gaps in treatment. The present technology may employ procedure codes to easily identify procedures, medications, etc.

In one embodiment, the gaps in treatment may be used to provide improved care to a patient at medical standard of care. Such care may be provided by physicians, nurses and other medical professionals. However, care may also be provided to patients based on the gaps in treatment where the care giver is a non-physician. The present technology allows a non-physician to provide care to a patient at a standard of care at least equal to the standard of care that is upheld by a physician treating a patient. This is accomplished by providing information to the non-physician or other care giver that allows effective treatment of the patient. The information provided is generated by algorithms and other methods described herein where the information recommends treatments for the patient based on a physician level standard of care.

For example, a doctor may prescribe a medication and then be alerted by the present technology that the prescription has not been obtained by the patient within a specified time period. Or the physician may be alerted that the patient has refilled the prescription too soon within a prescribed time period. In one embodiment, the present technology may identify a conflict between a prescription medication and non-prescription medication such as a vitamin, an herbal medicine, or an over the counter medicine.

In one embodiment, the alerts associated with the in treatment may assist the healthcare provider to make informed decision regarding the care of the patient. The alerts may also lead the healthcare provider to a diagnosis previously unrealized.

In one embodiment, the gap in treatment is related to lab results of test performed on the patient. For example, the gap in treatment may show that a patient's cholesterol level is high or has been increasing over a period of time. This may also apply to other measurements such as blood pressure, weight, glucose levels, vital statistics, etc. In one embodiment, the gap in treatment can show that a patient is overdue for an eye exam or other test required in the care of the patient.

In one example, a patient with diabetes may visit the doctor for a reason unrelated to diabetes such as the patient stubbed her toe. The doctor may employ the present technology to discover a gap in the treatment of the patient related to the diabetes such as the patient has not come in for scheduled appointments, or has not filled prescriptions for insulin, etc. This may also lead the doctor to perform test or exams that may identify other issues associated with the gap in treatment that the present technology alerted the doctor to. Thus the doctor may treat the patient for issues that the patient was not aware of and that the doctor may not have been aware of had it not been for the present technology.

The present technology may generate reports that summarize the data related to the care of a patient. Such reports may be automatically generated and may be generated on a periodic basis. Different reports may show summaries, evaluations, progress summaries, timelines, and linear progression of conditions related to a patient. The reports allow a healthcare provider to evaluate trends and make proactive decisions related to the care of the patient. Such reports may also be useful to a healthcare provider who has not seen a patient before.

FIG. 5 illustrates the security components and data accuracy components of the HMS, demonstrating how the HMS's' architecture follows the C-I-A (Confidentiality-Integrity-Availability) principle of security. There are stringent security requirements enforced by several firewalls and intrusion detection systems. The security infrastructure for the HMS affords authorized care managers to access the HMS easily while preventing unauthorized access and auditing each and every data access.

The primary internet firewall 54 may be of any of the known systems designed to prevent unauthorized access to or from a private network. Firewalls can be implemented in both hardware and software, or a combination of both. Firewalls are frequently used to prevent unauthorized Internet users from accessing private networks connected to the Internet, especially intranets. All messages entering or leaving the intranet pass through the firewall, which examines each message and blocks those that do not meet the specified security criteria.

The Internet Firewall 54 in the HMS allows only https (Hyper Text Transport Protocol over SSL) traffic to pass through to the HMS web server from IP addresses that are allowed to access the HMS.

The redundant internet firewall 56 is a standby firewall that monitors the primary internet firewall 54 for availability. In the event of failure of the primary internet firewall 54, the standby internet firewall 56 assumes the responsibility of primary internet firewall 54 with minimal interruption to the availability of the HMS.

The primary web server 58 delivers (serves up) Web pages. Each Web server has an IP address and possibly a domain name. For example, if you enter the URL https://docs.ahcrx.com/docs in your browser, this sends a request to the server whose domain name is docs.ahcrx.com. The server then fetches the page named index.html and sends it to your browser.

The HMS preferably utilizes a version of Apache web server that is always kept up-to-date. The Apache web server serves as proxy to the HMS application server.

The primary application firewall 62 protects the application server by restricting access to the application server 58.

The standby application firewall 64 monitors the primary application firewall 62 for availability. In the event of failure of the primary application firewall 62, the standby application firewall 64 assumes the responsibility of primary application firewall 62 with minimal interruption to the availability of the HMS.

The HMS may be deployed on a Java application, for example one distributed by JBoss, a subsidiary of Red Hat Inc. The primary application server 66 provides a container for services like database connection, application security and application deployment over the Web.

The standby application server 68, with the High Availability (HA) system, monitors the status of the primary application server 66 for availability and in the event of physician server failure of the primary application server 66; affected applications are automatically restarted on other production servers with spare capacity. In the case of operating system failure, our HA system restarts the affected physical server. This provides the ability to deliver the level of availability required for all of the important applications.

The HMS may utilize as the primary database server 76 an enterprise Relational Database Management System for storing all the data pertaining to the HMS. All data is mirrored and backed up off site.

The standby database server 78 monitors the status of the primary database server 76 and assumes the responsibility of the primary responsibility if the Primary Database Server fails minimizing unavailability of the HMS.

Hard Drive Physical Storage (79) may be provided by San file storage, as the hard drive with logical and physical redundancy storage.

Every database transaction in the HMS is crucial and cannot be lost. It is possible that a server may fail as a result of hardware or software failure. The HMS is implemented on a pair of databases for database replication 80. There is a primary database and secondary database. All transactions from the primary database are copied to the secondary or standby database in real-time mode. This mode of replication guarantees nearly 100% up time of the application and insures 0 data loss.

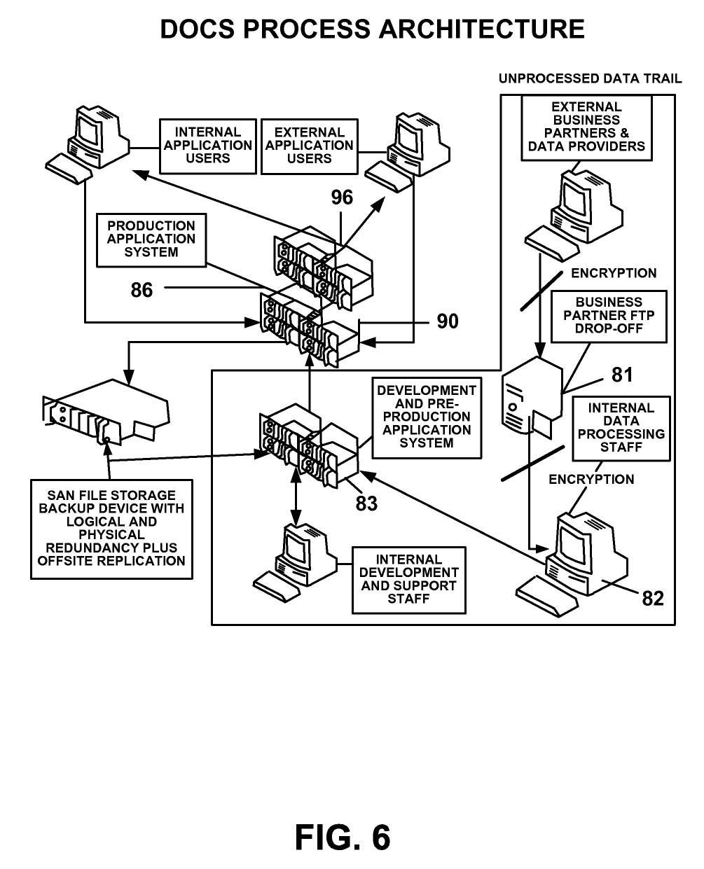

Turning now to FIG. 6, the drawing describes the HMS encryption, which is employed at two levels. The entire data exchange between the client machine and the HMS server is encrypted using SSL technology with 256 bit key. All private information within the database are encrypted using 3DES and MD5 algorithms.

Secure FTP refers to the practice of tunneling a normal FTP session over an

SSH connection, providing an FTP site for data delivery 81. Unlike standard FTP, it encrypts both commands and data, preventing passwords and sensitive information from being transmitted in the clear over the network SSH (Secure Shell) is a protocol for creating a secure connection between two computers. American Health Care employs the latest Secure FTP (SFTP) servers for transferring files using either a local client application or a web site portal.

The HMS helps the care managers to manage the health of the members with the help of two sets of information; historical claims and information gathered during the visit of the member. The HMS employs a data load process 82 with sophisticated data cleaning and loading processes to input medical and pharmacy claim information for each member.

The development and pre-production application system 83, and its mirrored copy, are housed in a separate physical location from the production application system to ensure program security and the integrity of the production server.

The first login pop up to the user is provided by the Apache web server. Web server replication 86 is yet another example of the usability feature of the HMS. In the event of failure of the primary web server, the user authentication information remains available on the primary server.

The HMS provides high availability by using a combination of hardware and software clustering 90. Hardware clustering makes two or more computers appear as one computing node. Hardware Clustering makes more computer power available for the application. The HMS is designed for hardware clustering of the database.

The HMS employs software clustering for the web server and the application server. The web server and the application server are configured identically for fail over scenario. In the case of the failure of the primary web server, the secondary web server takes over the load in a manner that keeps the switchover transparent to the users. There is similar software clustering in place for the application server.

The High Availability (HA) system monitors the status of the Primary Application Server for availability and in the event of physical server failure of the Primary Application Server; affected applications are automatically restarted on other production servers with spare capacity. In the case of operating system failure, our HA system restarts the affected physical server. This provides the ability to deliver the level of availability required for all of the important applications.

The HMS employs rigorous user access control mechanism 96 to ensure that only authorized users have access to the data.

There are several aspects to the user access control mechanism 96. Following is the list.

1. Only users from a white list of IP addresses are allowed to access the HMS web site.

2. When a user accesses the HMS web site, they are presented with a pop up screen that demands authentication information. This is controlled by the web server.

3. Once, the user has been authenticated by the web server, she has to again enter her login and password at the home page of the HMS.

4. The HMS controls which groups the user has access to, the subset of members within the group the user can manage and the types of data this user can manipulate.

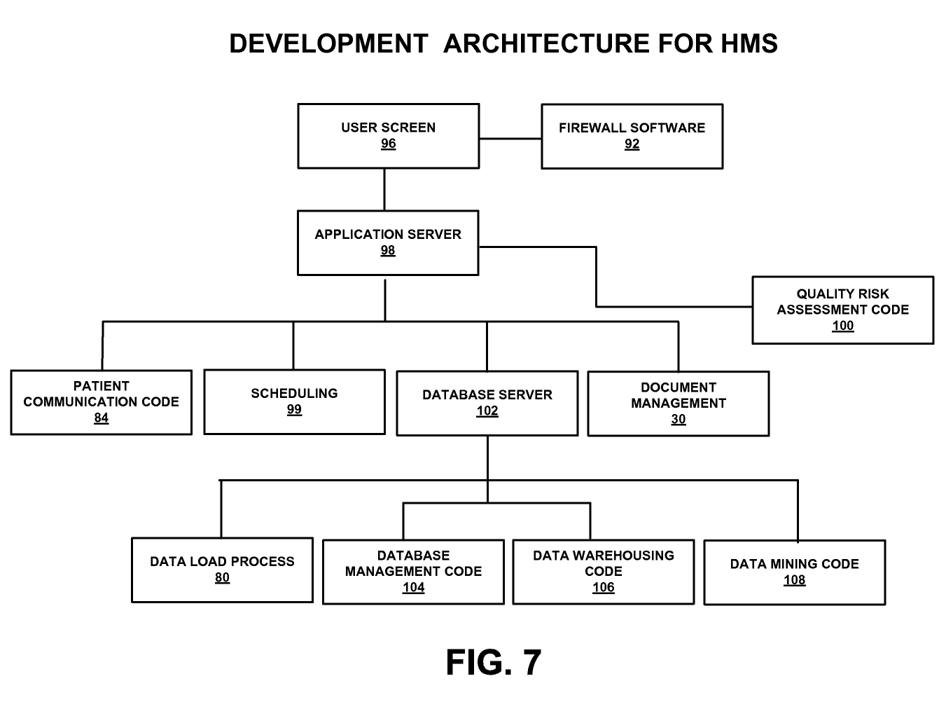

A schematic diagram of an exemplary system of various databases and software modules is illustrated in FIG. 7. An electronic medical document database 30 (FIG. 1), 102, is in communication with an application server 98. A plurality of modules 96, 84, 99, 30, 100, 80, 104, 106, 108 are in communication with the application server 98. The program may be embodied in the application server 98.

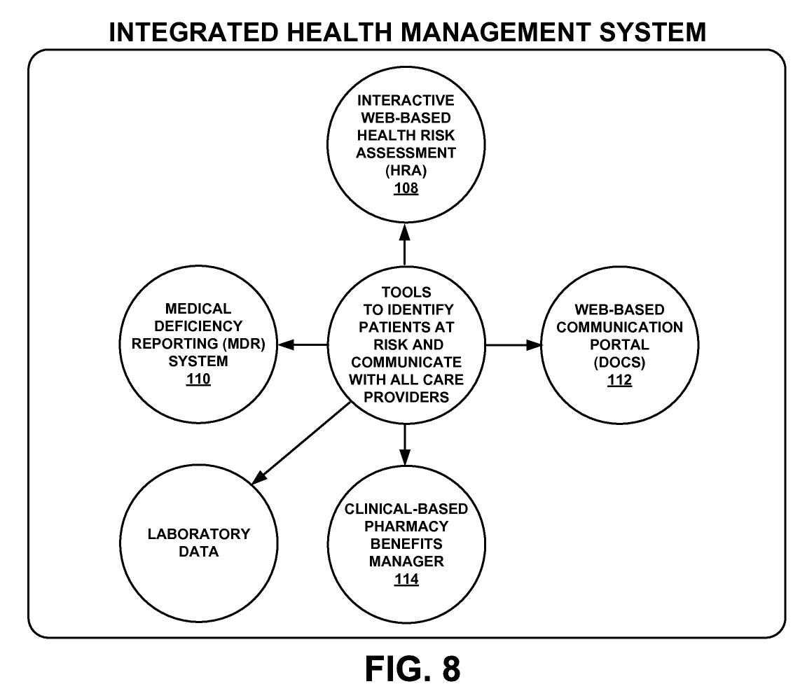

FIG. 8 illustrates an embodiment of the HMS 38. The utilities, tools, modules, or any other HMS 38 component, may interact with any number of additional computing systems and databases in order to facilitate, for example, administration, matching, security, appointment scheduling, electronic prescribing, registration, advertising, and etc. Computing systems and databases residing outside of HMS 38 may be administered by any other third party entity directly or indirectly involved in facilitating the disclosed system and having secured authorization by the HMS and IT administrators. Such third party entities may include governmental organizations, financial institutions, non-profit organizations, small businesses, corporations, and the like.

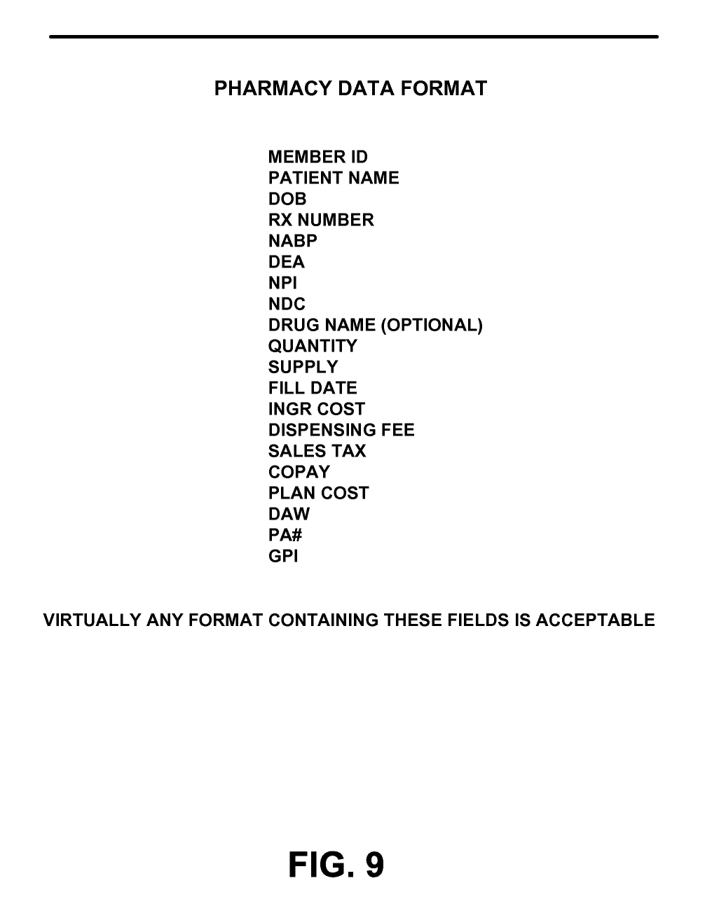

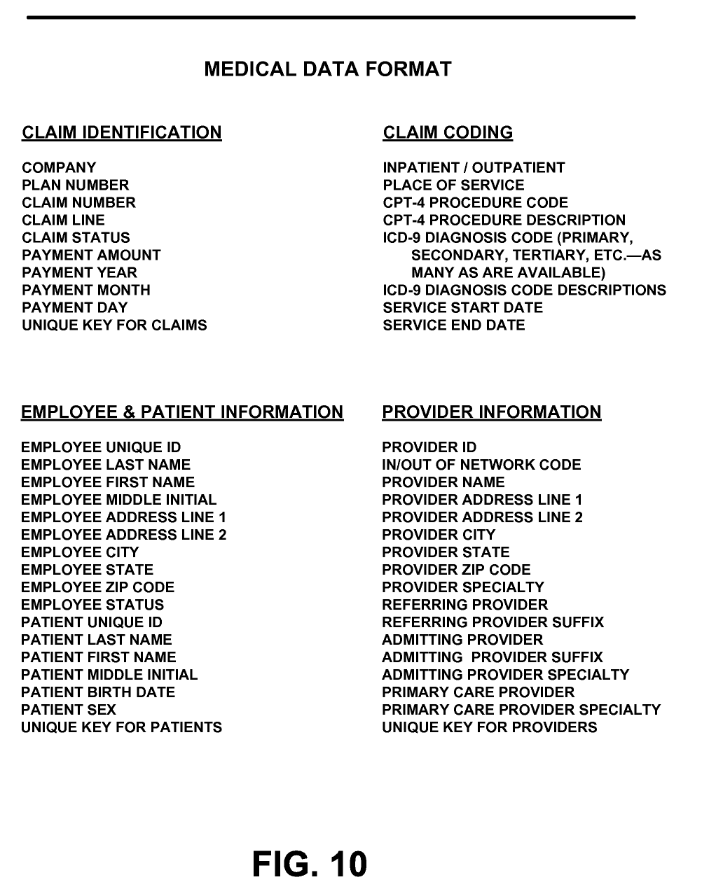

The program is further operable to provide-one or more templates for the submission of information. FIGS. 9, 10 and 13 illustrate exemplary pharmacy and medical data formats used to input information into the various databases comprising the HMS. The program may present a list, for example, of different types of templates and enable the user to select a template from the list of templates. A template may include certain preformatted information with fields for the user to populate with information. The program may further enable users to create and/or modify templates, may provide fill information with which to populate templates, and may allow users to customize the fill information. In one embodiment, the template emulates a standard medical chart or record such as a paper doctor's chart. Such a template may be referred to as an electronic medical record. In one embodiment, the template employs a graphical user interface and a computer system.

The inputted and outputted data may include information that is regularly 11 recorded either by persons working with a patient or automatically by monitoring equipment. By way of example, the providers, 16, or care managers, 31, may input patient encounter data, 15, 19, such as temperature, pulse, weight, and so forth, or may include information about medication administered to the patient, 40, 41, or other treatment information, 22, 26.

By way of further example, an attending physician, 16, may create a note relating to a patient, 11, and store the note, 15, 19, in the patient records database 30. The attending physician, 16, or other caregiver, 31, such as a consulting physician, 16, or medical student, 16, may view the note at a later time and add information to the note. When the note is complete, the attending physician, 16, may submit the note to the electronic medical document database 30 and sign the note.

FIG. 14 shows an example embodiment of interface 1300 that is designed to emulate a standard doctor's chart or record in an electronic format on a display. In one embodiment, interface 1300 includes object 1340 that serves to make the electronic medical record look like a paper medical records. Object 1340 may emulate a clipboard or other paper fastening device. The purpose of object 1340 is to make interface 1300 look and feel like a paper medical record such that a healthcare provider who has not previously used interface 1300 may use interface 1300 and immediately feel familiar with it.

In one embodiment, interface 1300 comprises tabs 1305, 1310 and 1315. Tabs 1305, 1310 and 1315, when selected, switch the display to a different view. This is to emulate the process of turning the page in a paper record. The tabs may also emulate actual plastic tabs at the top of a paper medical chart that allow for a user to switch between sections of the medical chart. It should be appreciated that interface 1300 may employ more than or less than three tabs. In one embodiment, tabs 1305, 1310 and 1315 may be shown in a graphical interface that represents pages in the electronic medical record. The tabs may be titled to represent the page with titles such as search, scheduling, summary, disease management, documents, comments, and the like including abbreviations. When a user selects a tab the user is presented with a display.

In one embodiment, interface 1300 may display user information 1320 which displays information regarding the user of the electronic medical record. Such information may include the username of the account logged into the electronic medical record, patient information, etc. The graphical displays associated with tabs 1305, 1310 and 1315 and user information 1320 may not change as different tabs are selected by a user.

In one embodiment, a page associated with electronic medical record may display fields 1325, 1330, and 1335. Fields 1325, 1330, and 1335 may be used to display information or receive information or both. Fields 1325, 1330, and 1335 may be located at different location than what is depicted in interface 1300 and interface 1300 may include more or less than three fields. Fields 1325, 1330, and 1335 may display data related to patient identity, patient medical treatment, gaps in treatment, reports, or other data as described for FIG. 4.

In one embodiment, fields 1325, 1330, and 1335 are data entry fields that allow limited options for entry. This may include a drop down menu that require a user to select one of a number of options. Such limits reduce the number of errors in data entry for the present technology. Limits also ensure that values are within specified parameters.

FIG. 11 shows several user devices 116(A)-116(F) connected over the HMS networks 18. The method of the present technology is especially well-suited for implementation on a computer or computer network as illustrated in FIG. 11. It will be appreciated that any or all of the databases and software modules discussed herein may be effectively implemented on various combinations of computing devices, or even on a single computing device. In one embodiment, user devices 116(A)-116(F) are electronic devices configured to display a graphical interface of a an electronic medical record having data related to a patient wherein the graphical interface emulates a standard paper medical chart, and configured to receive additional information from a healthcare provider regarding the patient wherein said additional information is received in data fields associated with the graphical interface, and further configured to display an alert regarding a gap in a treatment of said patient.

The program is operable to identify particular data from the electronic medical document database 30. By way of example, the program may identify patients 11 on a list of patients as current patients, wherein the list is maintained by caregivers 16, 31. Alternatively, the program may identify patients 11 according to data in the electronic medical document database 30, such as a data field relating to each patient indicating a status 39 of the patient 11.

### Operation

More generally, in embodiments in accordance with the present invention, a healthcare management system is utilized to manage the healthcare of a patient. Such methods can be implemented using hardware devices described herein.

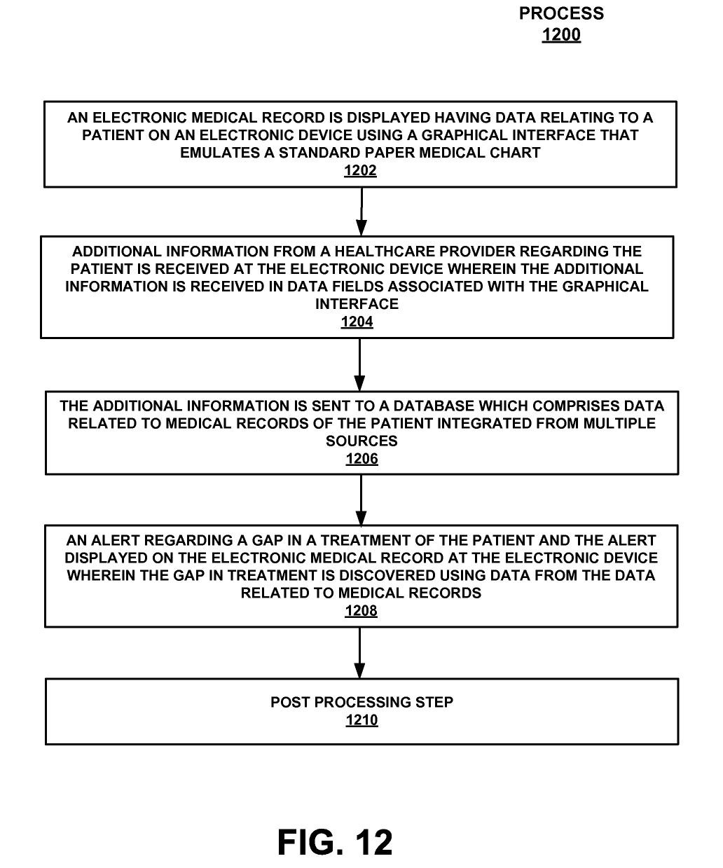

FIG. 12 is a flowchart illustrating process 1200 for managing medical care, in accordance with one embodiment of the present invention. In one embodiment, process 1200 is carried out by processors and electrical components under the control of computer readable and computer executable instructions stored on a computer-usable storage medium. The computer readable and computer executable instructions reside, for example, in data storage features such as computer usable volatile and non-volatile memory. However, the computer readable and computer executable instructions may be non-transitory and may reside in any type of computer-usable storage medium.

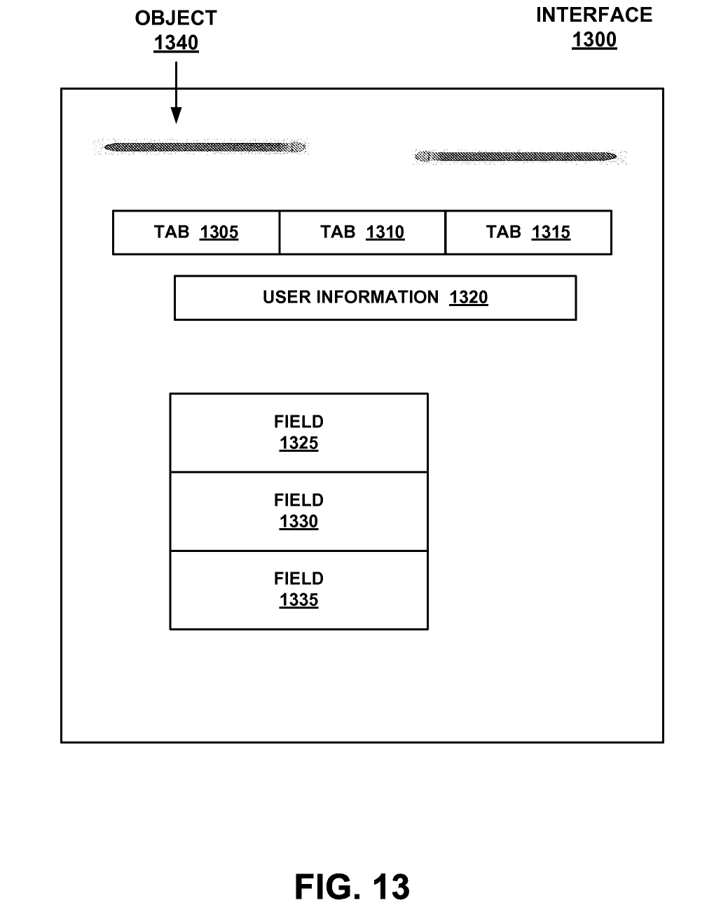

At 1202, an electronic medical record is displayed having data related to a patient on an electronic device using a graphical interface that emulates a standard paper medical chart. In one embodiment, the graphical interface is a Graphical User Interface (GUI) used in conjunction with an electronic device such a computer system that allows users to select objects on the display to perform tasks. In one embodiment, the graphical interface is interface 1300 of FIG. 13. The standard paper medical chart may refer to several standard medical charts used in the medical industry. Such a chart may be employed by doctors, physicians, nurses, pharmacists, technicians, administrators, assistants, etc. The standard paper medical chart is not limited to one type of chart. In one embodiment, the graphical interface emulates a standard paper medical chart so that a user familiar with a standard medical chart may use the electronic medical record via the graphical interface without any specific or additional training. Thus a physician may experience a similar look and feel using the present technology as she would experience using standard paper charts and medical records. In one embodiment, the electronic device is one of the user devices described in FIG. 11.

At 1204, additional information from a healthcare provider regarding the patient is received at the electronic device wherein the additional information is received in data fields associated with the graphical interface. Such information may be, but is not limited to, documents, x-rays, lab results, patient symptoms, records of medications, records of treatments, records of procedures, patient tests, healthcare provider notes, comments, and patient vital statistics. The healthcare provider may be any person associated with the care and treatment of the patient. In one embodiment, a physician may enter the additional data while examining the patient in a fashion similar to a physician using a paper chart.

In one embodiment, the data fields may be the data fields described and depicted in FIG. 13. In one embodiment, data fields associated with the electronic medical record have a limited number of options for receiving input. For example, the data field may be associated with a measurement of a patient's blood pressure. The limited number of options for the data field may be that only whole numbers within a range of numbers may be entered into the data field. The range of numbers may be displayed in a drop down menu if the given data field is selected or the user may be required to type in the number. Other data fields may be limited to options such as yes, no, or unknown. Limiting options provides for reduced errors being entered into the electronic medical record. Additionally, limiting options also ensures that all personal using the electronic medical record enter data according to the same standards. For example, measurements may be taken using different measuring systems such as standard vs. metric, but the electronic medical record may require the use of only one system. In one embodiment, where the data field has limited options, there may be an additional data field that allows a user to enter notes or comments regarding the data being inputted. Such notes or comments may not be automatically displayed on the electronic medical record, but may be displayed if an option is selected.

At 1206, the additional information is sent to a database which comprises data related to medical records of the patient integrated from multiple sources. In one embodiment, the database is networked to the electronic device. In one embodiment, the database is located or is part of the electronic device. In one embodiment, the database is part of a computer system such as those described in FIGS. 5 and 6.

It should be appreciated that the database is able to integrate data from multiple sources. Such data may be directly inputted into the database or it may be uploaded to the database from another database, system, or document. The data from multiple sources may come from, but is not limited to documents, medical or doctor charts, prescriptions, pharmaceutical records, medication records, information from the patient, x-rays, lab results, patient symptoms, records of medications, records of treatments, records of procedures, patient tests, healthcare provider notes, comments, prescriptions not filled, missed appointments, procedures performed, lab values, patient history, non-prescription medications taken by patient, herbal medicines used by patient, diet information, and patient vital statistics. Thus the present technology may integrate all or nearly all data collected regarding the treatment of a patient.

At 1208, an alert regarding a gap in a treatment of the patient and the alert displayed on the electronic medical record at the electronic device wherein the gap in treatment is discovered using data from the data related to medical records. It should be appreciated that the gap in treatment may be, but is not limited to identifying conflicting medications, identifying a condition the patient is at risk for, identifying a prescription for the patient that has not been filled, identifying a prescription for the patient that has been refilled more frequently than recommended, recommending a medication for the patient to use, displaying an evaluation of treatment of the patient on a periodic basis, trends in treatment of the patient, and identifying a treatment the patient should undergo. In one embodiment, the gap in treatment is the same as a deficiency in care previously described. The alert may be in the form of a report or other notification. The alert may be displayed on the electronic medical record using the graphical interface.

In one embodiment, the alert regarding gap in treatment may be provided to a non-physician and used to provide care to a patient at medical standard of care. The present technology provides information and recommendations, such as gaps in treatment, to a non-physician to provide care to a patient at a standard of care at least equal to the standard of care that is upheld by a physician treating a patient.

In one embodiment, the gap in treatment is discovered using the electronic device and the data regarding the patient that the electronic device has access to. In one embodiment, the gap in treatment is discovered at a computer system associated with the database. In one embodiment, the gap in treatment is discovered at a third device networked with the electronic device and the computer system associated with the database.

In one embodiment, the electronic medical record may include generating reports or evaluations. Such reports may display or highlight the described gaps in treatments. The reports or evaluations may be generated automatically and may be sent automatically to specified persons. In one embodiment, the report is a summary of medical treatment for the patient displayed on the electronic medical record. Such a summary may be used by a doctor for a variety of reasons such as to refresh her memory regarding a patient, used to evaluate treatment with the patient during an exam, used by a healthcare professional that is examining a patient for the first time, identify trends in the patient or the patient's disease, etc. In one embodiment, the report or evaluation of the medical treatment comprises a timeline of medical treatment for the patient. Such a timeline may be useful for a healthcare professional to quickly assess the status of a patient. In one embodiment, the reports or evaluations are generated on a periodic basis such as once a month, once a week, once a year, etc. The reports and evaluations may be quickly generated using the present technology. Such reports provide an advantage for the electronic medical record over traditional paper records because the report can be generated automatically in a matter of seconds. The reports may be highly beneficial for a healthcare provider but were previously unfeasible to use on a regular basis because of the time and expense associated with creating a report when using paper records and charts.

In one embodiment, post processing step 1210 comprises the step that the electronic medical record is displayed on a second electronic device. In one embodiment, the second electronic device is one of the user devices described in FIG. 11. Thus more than one person associated with the care of the patient may access the electronic medical record of the patient. This is a vast improvement over paper charts where there may be only one copy of a patient's chart, or there may be two similar charts but each chart may have different information on it.

In one embodiment, the electronic medical record may be simultaneously displayed on a plurality of electronic devices giving access to multiple users or healthcare professionals. The users may be remote or local. The users may be, but are not limited to, healthcare professionals such as doctors, physicians, technicians, labs, pharmacists, nurses, assistants, psychologists, therapists, as well as other staff such as computer technicians, billing specialists, administrators, individuals cleared by HIPPA to view portions of medical records or any other healthcare professional associated with providing healthcare to the patient.

In one embodiment, post processing step 1210 comprises the data related to the patient displayed on the second electronic device is limited to provide only data that a given user is authorized to view. In one embodiment, the data is not limited. Limiting the data may be useful in situations where the user accessing the electronic medical record is not fully authorized to view or access all data regarding the patient. For example, there may be a limited user such as a billing technician that only needs to access information for the patient to bill the patient for services rendered. In this example the billing technician does not need to know all information about the patient such as information regarding family history or past procedures performed.

The ability to limit information to a particular user may be accomplished with user accounts. For example the billing technician may log into a system using the electronic medical record with a user account comprising a username and password particular to the billing technician while a physician treating the patient would have different user account. The limits may be placed on the user by placing limits to what data a given user account may access.

In one embodiment, these limits may be employed when a first healthcare professional is giving access to a second healthcare professional, via the electronic medical record, where the law prohibits the first healthcare professional from divulging certain data about the patient due to patient confidentiality.

In one embodiment, post processing step 1210 comprises a first page of data is displayed using the graphical display of the electronic medical record. In one embodiment, post processing step 1210 comprises a selection of a tab associated with the graphical display of the electronic medical record is received. In one embodiment, post processing step 1210 comprises a second page of data is displayed using the graphical display of the electronic medical record. The first page, the second page and the tab may be similar to what is described in FIG. 13.

In one embodiment, post processing step 1210 comprises a command is received via the graphical interface at the electronic device to generate a bill related to a treatment of the patient. In one embodiment, post processing step 1210 comprises the bill is generated at the electronic device. For example, a billing specialist may access the electronic medical record and see that a procedure was performed for a patient. The specialist may then use the electronic medical record and/or the graphical interface to send a bill to the patient. The bill may be sent electronically or the bill may be printed onto a medium and sent to the patient.

In one embodiment, post processing step 1210 comprises a report related to services performed by the healthcare provider generated at the electronic device. In one embodiment, the report is generated at the computer system associated with the electronic device. The report may show all procedures, treatments, appointments, etc. associated with a particular healthcare provider. The report may be used by an administrator or other entity to evaluate care given by the particular healthcare provider. The report may highlight anomalies or deficiencies in the care given based on standard of care for a patient. The standard of care may be associated with patients suffering from a particular disease. For example, a patient may have diabetes and the standard of care for patients with diabetes includes a certain test performed by a doctor on a regular basis. The report may show that the doctor has not performed the certain test for this patient at the appropriate times. This information may be highlighted in the report and used by an administrator or other authorized entity to make administrative decisions.

In one embodiment, the medical data related to the patient is text searchable via the graphical interface of the electronic medical record. This highly useful for a healthcare provider to quickly search for and find all types of information. For example, a healthcare professional may receive results of a blood test for a patient and can then quickly find the results of a previous blood test for the same patient and compare the two results. Such a search may be performed simply by searching for the key words blood test. Searches may also be performed for a variety of items including a timeline of appointments with a patient, lab results, medicines prescribed, procedures performed, past symptoms, etc. In one embodiment, a healthcare provider using the present technology may have access to electronic medical records for more than one patient. A text search may allow the present technology to quickly display an electronic medical record for a given patient. Thus a healthcare provider may easily switch between different electronic medical records for different patients.

Although embodiments of the present technology have been described with reference to the attached drawings, it is noted that equivalents may be employed and substitutions made herein without departing from the scope of the subject matter recited in the claims.

While this technology has been described in conjunction with the specific embodiments outlined above, it is evident that many alternatives, modifications and variations will be apparent to those skilled in the art. Accordingly, the preferred embodiments of the technology, as set forth above, are intended to be illustrative, not limiting. Various changes may be made without departing from the spirit and scope of this technology.

Unless defined otherwise, all technical and scientific terms used herein have the same meaning as commonly understood by one of ordinary skill in the art to which this technology belongs. Although any methods and materials similar or equivalent to those described herein can also be used in the practice or testing of the present technology, the preferred methods and materials are now described.

The citation of any publication is for its disclosure prior to the filing date and should not be construed as an admission that the present technology is not entitled to antedate such publication by virtue of prior technology. Further, the dates of publication provided may be different from the actual publication dates which may need to be independently confirmed.

It must be noted that as used herein and in the appended claims, the singular forms “a”, “an”, and “the” include plural referents unless the context clearly dictates otherwise. It is further noted that the claims may be drafted to exclude any optional element. As such, this statement is intended to serve as antecedent basis for use of such exclusive terminology as “solely,” “only” and the like in connection with the recitation of claim elements, or use of a “negative” limitation.

As will be apparent to those of skill in the art upon reading this disclosure, each of the individual embodiments described and illustrated herein has discrete components and features which may be readily separated from or combined with the features of any of the other several embodiments without departing from the scope or spirit of the present technology. Any recited method can be carried out in the order of events recited or in any other order which is logically possible.

While this technology has been described in conjunction with the specific embodiments outlined above, it is evident that many alternatives, modifications and variations will be apparent to those skilled in the art. Accordingly, the preferred embodiments of the technology, as set forth above, are intended to be illustrative, not limiting. Various changes may be made without departing from the spirit and scope of this technology.

What is claimed is:

1. A method for managing medical care, said method comprising:
displaying an electronic medical record having data related to a patient on an electronic device using a graphical interface that emulates a standard paper medical chart;
receiving additional information from a healthcare provider regarding said patient at said electronic device wherein said additional information is received in data fields associated with said graphical interface;
sending said additional information to a database which comprises data related to medical records of said patient integrated from multiple sources; and
receiving an alert regarding a gap in a treatment of said patient and displaying said alert on said electronic medical record at said electronic device wherein said gap in treatment is discovered using data from said data related to medical records.

2. The method of claim 1 wherein said gap in said treatment is selected from a group consisting of: identifying conflicting medications, identifying a condition said patient is at risk for, identifying a prescription for said patient that has not been filled, identifying a prescription for said patient that has been refilled more frequently than recommended, recommending a medication for said patient to use, displaying an evaluation of treatment of said patient on a periodic basis, trends in treatment of said patient, and identifying a treatment said patient should undergo.

3. The method of claim 1 wherein said database is connected to said electronic device over a local area network.

4. The method of claim 1 wherein said database is remotely connected to said electronic device over a network.

5. The method of claim 1 wherein said displaying said electronic medical record may be simultaneously displayed on a plurality of electronic devices.

6. The method of claim 1, further comprising:
displaying said electronic medical record on a second electronic device; and
limiting said data related to said patient displayed on said second electronic device.

7. The method of claim 1 wherein said additional information from said healthcare provider is selected from a group of additional information consisting of: documents, x-rays, lab results, patient symptoms, records of medications, records of treatments, records of procedures, patient tests, healthcare provider notes, comments, and patient vital statistics.

8. The method of claim 1, wherein data fields associated with said electronic medical record have a limited number of options for receiving input.

9. The method of claim 1, further comprising:
displaying a first page of data using said graphical display of said electronic medical record;
receiving a selection of a tab associated with said graphical display of said electronic medical record; and
displaying a second page of data using said graphical display of said electronic medical record.

10. The method of claim 1, wherein said displaying said electronic medical record displays a summary of medical treatment for said patient.

11. The method of claim 10, wherein said summary of said medical treatment comprises a timeline of medical treatment for said patient.

12. The method of claim 1, wherein data related to said patient is text searchable via said graphical interface of said electronic medical record.

13. The method of claim 1, further comprising:
receiving a command via said graphical interface at said electronic device to generate a bill related to a treatment of said patient; and
generating said bill at said electronic device.

14. The method of claim 1, further comprising:
generating a report related to services performed by said healthcare provider.

15. The method of claim 1, wherein said alert regarding said gap in said treatment of said patient is provided to a non-physician to provide care to said patient at a medical standard of care.

16. A computer-usable storage medium having instructions embodied therein that when executed cause a computer system to perform a method for managing medical care, said method comprising:
displaying an electronic medical record having data related to a patient on an electronic device using a graphical interface that emulates a standard paper medical chart;
receiving additional information from a healthcare provider regarding said patient at said electronic device wherein said additional information is received in data fields associated with said graphical interface;
sending said additional information to a database which comprises data related to medical records of said patient integrated from multiple sources; and
receiving an alert regarding a gap in a treatment of said patient and displaying said alert on said electronic medical record at said electronic device wherein said gap in treatment is discovered using data from said data related to medical records.

17. The computer-usable storage medium of claim 16 wherein said gap in said treatment is selected from a group consisting of: identifying conflicting medications, identifying a condition said patient is at risk for, identifying a prescription for said patient that has not been filled, identifying a prescription for said patient that has been refilled more frequently than recommended, recommending a medication for said patient to use, displaying an evaluation of treatment of said patient on a periodic basis, trends in treatment of said patient, and identifying a treatment said patient should undergo.

18. The computer-usable storage medium of claim 16 wherein said displaying said electronic medical record may be simultaneously displayed on a plurality of electronic devices.

19. The computer-usable storage medium of claim 16, further comprising:
displaying said electronic medical record on a second electronic device; and
limiting said data related to said patient displayed on said second electronic device.

20. The computer-usable storage medium of claim 16 wherein said additional information from said healthcare provider is selected from a group of additional information consisting of: documents, x-rays, lab results, patient symptoms, records of medications, records of treatments, records of procedures, patient tests, healthcare provider notes, comments, and patient vital statistics.

21. The computer-usable storage medium of claim 16, further comprising:
displaying a first page of data using said graphical display of said electronic medical record;
receiving a selection of a tab associated with said graphical display of said electronic medical record; and
displaying a second page of data using said graphical display of said electronic medical record.

22. The computer-usable storage medium of claim 16, wherein said displaying said electronic medical record displays a summary of medical treatment for said patient.

23. The computer-usable storage medium of claim 16, wherein data related to said patient is text searchable via said graphical interface of said electronic medical record.

24. The computer-usable storage medium of claim 16, further comprising:
receiving a command via said graphical interface at said electronic device to send a bill related to a treatment of said patient; and
sending said bill from said electronic device.

25. The computer-usable storage medium of claim 16, wherein said alert regarding said gap in said treatment of said patient is provided to a non-physician to provide care to said patient at a medical standard of care.

26. A system for managing medical comprising:
an electronic device configured to display a graphical interface of an electronic medical record having data related to a patient wherein said graphical interface emulates a standard paper medical chart, and configured to receive additional information from a healthcare provider regarding said patient wherein said additional information is received in data fields associated with said graphical interface, and further configured to display an alert regarding a gap in a treatment of said patient;
a server networked to said electronic device and configured to store data related to medical records of said patient integrated from multiple sources and to receive said additional information from said electronic device and configured to generate said alert regarding said gap in said treatment of said patient wherein said gap in said treatment is generated based on said data related to medical records.
